(19) United States
(12) Patent Application Publication
(10) Pub. No.: US 2022/0168796 A1
(43) Pub. Date: Jun. 2, 2022

(54) METHOD AND APPARATUS FOR EMBOSSING AND DEBOSSING METALLIC CONTAINERS

(71) Applicant: BALL CORPORATION, Westminster, CO (US)

(72) Inventors: Kevin Reed Jentzsch, Woodland Hills, UT (US); Mark A. Jacober, Arvada, CO (US); David J. Bonfoey, Broomfield, CO (US)

(73) Assignee: BALL CORPORATION, Westminster, CO (US)

(21) Appl. No.: 17/672,535

(22) Filed: Feb. 15, 2022

Related U.S. Application Data
(62) Division of application No. 16/134,655, filed on Sep. 18, 2018.
(60) Provisional application No. 62/560,049, filed on Sep. 18, 2017.

(51) Int. Cl. B21D 51/26; B21D 22/28; B21D 22/30; B44B 5/00; B44B 5/02

(52) U.S. Cl. CPC B21D 51/2607; B21D 51/2646; B44B 5/026; B21D 22/30; B44B 5/0052; B21D 22/28

(57) ABSTRACT

Methods and apparatus of decorating metallic containers are provided. More specifically, the present invention provides novel apparatus and methods of forming an indicia or a decorative shape on a closed end-wall of a metallic container body. A tool of one embodiment of the present invention is operable to form an indicia in a metallic sheet. A cupping apparatus can subsequently form a cup from the metallic sheet which includes the indicia. The cup can be formed into a container body by a bodymaker. In another embodiment, a tool of a bodymaker is operable to form an indicia or a decorative shape in a closed end-wall during formation of a metallic container body. The indicia or decorative shape can be formed by coining, punching, embossing, debossing, and other techniques of forming and shaping metal material from which the metallic container body is formed. In this manner, the indicia may include one or more raised portions and sunken portions in the closed end-wall. Optionally, the indicia may enhance the strength of the closed end-wall, such as to prevent or resist buckling and deformation.

### CROSS-REFERENCE TO RELATED APPLICATIONS

This application is a Divisional Application of, and claims priority to, U.S. patent application Ser. No. 16/134,655, filed on Sep. 18, 2018, which claims priority under 35 U.S.C. § 119(e) to U.S. Provisional Patent Application Ser. No. 62/560,049 filed Sep. 18, 2017, which are both incorporated herein in their entirety by reference.

### FIELD

The present invention relates generally to the manufacture of containers. More specifically, this disclosure provides methods and apparatus of forming a decorative shape or an indicia on a closed end-wall or dome of a metallic container.

### BACKGROUND

Metallic containers offer distributors and consumers many benefits and are used to store a variety of products including beverages and food products. Some metallic containers, such as beverage containers, are formed of two separate pieces including a container body and a container end closure.

A prior art process of forming a container body generally starts with a coil of stock metal which is loaded onto an uncoiler that unwinds the stock metal. The stock metal is then received by a cupping apparatus. The cupping apparatus includes precision tooling to punch out blanks from the stock material and form the blanks into seamless cups.

The cups are then transported to a bodymaker which performs drawing, ironing, and/or other forming operations on the cups to form and shape container bodies. A cup is pushed through a series of ironing rings of the bodymaker to thin an outer wall to a selected thickness. During these ironing operations, a length of the outer wall is substantially increased to establish the fluid capacity of the container body. A closed end-wall of the cup is generally formed to define a recessed or concave dome surface to resist deformation due to internal fluid pressures.

The container body is thus formed from a single piece of metal and includes a closed end-wall, a sidewall portion, and an open end opposite of the closed end-wall. The closed end-wall may include a concave dome. A flange or peripheral curl can be formed on the upper-most portion of the sidewall to receive an end closure after the container body is filled with a product, such as a beverage.

Optionally, the container body is transported to downstream equipment where subsequent operations are performed. For example, the container body may be transported to a decorator. Decorators typically use an ink, a paint, a varnish, and other coatings or laser marking to decorate the sidewall portion of the container body with an image or indicia, such as a brand name, logo, product information, or other design. However, the closed end-wall of container bodies are not currently decorated or otherwise shaped to provide any indicia, ornamental features, logos or other markings.

Accordingly, there is an unmet need for methods and apparatus of forming a decorative shape or an indicia on a closed end-wall of a container body without sacrificing production efficiency in a high-speed metallic container manufacturing process.

### SUMMARY

The present invention provides methods and apparatus of shaping the metal of a closed end-wall portion of a container body to form a decorative shape, an indicia, or other marking. The indicia can be formed by at least one of embossing, debossing, stamping, and coining the metal of the container body. The indicia can include at least one of a raised portion and a sunken or indented portion formed in the closed end-wall. In one embodiment, the indicia improves the strength of the closed-end wall. More specifically, the indicia can have a shape configured to make the closed end-wall more rigid.

One aspect of the present invention is an apparatus which includes tools to form a decorative shape or an indicia on a metallic sheet from which a container body is subsequently formed. The tools apply a force to predetermined portions of the metallic sheet to form the indicia on the metallic sheet. In one embodiment, the tools are operable to emboss, deboss, coin, or stamp the metallic sheet.

In one embodiment, the metallic sheet with the indicia is subsequently transported to a cupping apparatus which punches a blank including the indicia from the metallic sheet. Optionally, in another embodiment, the cupping apparatus includes the tools to form the decorative shape or indicia. The blank is formed into a cup by the cupping apparatus. A bodymaker then forms the cup with the indicia into a container body. When the container body is ejected from the bodymaker, the indicia is in a predetermined portion of the closed end-wall.

In one embodiment, the apparatus uses a coining method to form the indicia on a first surface of the metallic sheet. More specifically, in one embodiment the tools to form the decorative shape or indicia include a punch. The punch is configured to contact the first surface of the metallic sheet. The punch includes a geometric profile configured to form the indicia. The punch can be configured to form an indicia that includes a raised portion which extends above the first surface of the metallic sheet. In one embodiment, the punch includes a dome shaped surface. The geometric profile of the punch can be formed on the dome shaped surface. The geometric profile can extend outwardly from the dome shaped surface. In one embodiment, the geometric profile can be recessed or extends inwardly from the dome shaped surface. Optionally, the dome shaped surface is generally convex. In one embodiment, the punch is configured to form an indicia that extends above a first plane defined by the first surface of the metallic sheet. Additionally, or alternatively, the punch can be configured to form an indicia which includes a sunken portion. The sunken portion can be lower than the first surface. For example, at least a portion of the indicia formed by the punch can be recessed into the first surface.

The apparatus can include a second tool in opposing relationship with the punch. The second tool can be positioned proximate to an opposing second surface of the metallic sheet. The second tool can include a surface which supports the second surface of the sheet as the punch contacts the first surface. In one embodiment, the surface of the second tool is generally planar. Alternatively, the surface of the second tool is dome shaped. The surface can be concave. Optionally, the indicia is not formed on the second surface of the metallic sheet. Alternatively, the second tool can include a geometric profile generally corresponding to the geometric profile of the punch. In one embodiment, the geometric profile of the second tool includes a recessed portion. Thus, after the punch and the second tool contact the metallic sheet, the metallic sheet can include a first indicia on the first surface and a second indicia on the opposing second surface. Optionally, the first indicia can be different than the second indicia. Alternatively, the first indicia can be a reverse of the second indicia.

In another embodiment, the apparatus includes a male punch positioned proximate to the first surface of the metallic sheet. The male punch includes a geometric profile with a positive (or “embossed” or “raised”) shape. A female die is positioned proximate to the second surface of the metallic sheet in mating alignment with the male punch. The female die has a geometric profile with a debossed portion that has a negative (or sunken) shape. The apparatus moves the male punch and the female die into contact with the respective first and second surfaces of the metallic sheet substantially simultaneously. In this manner, the punch and die form a first indicia on the first surface and a second indicia on the opposing second surface of the metallic sheet.

Optionally, in yet another embodiment, the apparatus includes a punch with a geometric profile comprising an embossed portion with a predetermined shape. The punch is positioned proximate to the first surface of the metallic sheet. A die is positioned proximate to the second surface of the metallic sheet and is aligned with the punch. Optionally, the die includes an extension to apply a force to the second surface. In one embodiment, the extension of the die is at least partially compressible. The force from the die presses or forces the first surface of the metallic sheet against the punch such that the geometric profile is transferred from the punch and forms an indicia on the first surface of the metallic sheet. Additionally, or alternatively, an extension can be affixed to the punch.

Another aspect of the present invention is a bodymaker with tools to form a predetermined shape or embossed/debossed indicia on a closed end-wall of a metallic container body. The tools are configured to emboss or deboss predetermined portions of a metallic cup as the bodymaker transforms the metallic cup into the metallic container body. In this manner, the bodymaker forms the predetermined shape or embossed/debossed indicia in a predetermined portion of the closed end-wall of the metallic container body.

In one embodiment, the tools of the bodymaker employ a coining method to form an indicia in a metallic material of the closed end-wall. A geometric profile is formed on a portion of a dome die of the bodymaker. The geometric profile can extend from the dome die. Optionally, a portion of the geometric profile may be recessed into the dome die. The dome die is positioned proximate to an exterior surface of the closed end-wall. The dome die can include a convex surface with the geometric profile. The convex surface can be configured to apply a force to an exterior surface of a closed end-wall of the metallic container body.

A punch bolt of the bodymaker is positioned proximate to an interior surface of the closed end-wall within the metallic container body. The punch bolt can include a concave surface configured to apply a force to the interior surface of the closed end-wall. The dome die and punch bolt can be moved together such that the geometric profile of the dome die contacts the exterior surface of the closed end-wall and the closed end-wall is compressed between the dome die and the punch bolt. The geometric profile of the dome die can thus form an indicia on the exterior surface of the closed end-wall. In one embodiment, the indicia is not formed on the interior surface. In another embodiment, the punch bolt includes a negative of the geometric profile. Accordingly, in one embodiment, the tools of the bodymaker are configured to form a first indicia on the exterior surface and a second indicia on the interior surface of the closed end-wall.

In another embodiment, an extension is positioned on a portion of the dome die proximate to the exterior surface of the closed end-wall. The extension is configured to form an indicia on the exterior surface of the closed end-wall. More specifically when the dome die and the punch bolt are moved into contact with the respective exterior and interior surfaces of the closed end-wall, the extension applies a pressure or force to the exterior surface to form the indicia. In one embodiment, extension of the dome die is formed of a material that is at least partially compressible. In another embodiment, hydraulic pressure is applied to the extension. The hydraulic pressure causes the extension to move away from the dome die to apply the pressure to the closed end-wall. Optionally, in another embodiment, the extension is positioned on a portion of the punch bolt proximate to the interior surface of the closed end-wall.

In one embodiment, the dome die includes a plurality of apertures to transmit fluid to apply the hydraulic pressure the extension. The fluid can be an oil, water, or a gas such as air. The bodymaker can include a valve. The valve is operable to control the transmission of the fluid through the apertures. In one embodiment, the valve can control a volume, a pressure, and a timing of the fluid transmitted through the apertures. In one embodiment, the dome die includes two or more valves configured to selectively transmit the fluid to two or more groups of apertures.

It is one aspect of the present invention to provide an apparatus to form an indicia with at least one of an embossed portion and a debossed portion on a metal sheet in a container body manufacturing process. The apparatus generally includes, but is not limited to: (1) a first tool including a first indicia forming surface to apply a force to a first surface of the metal sheet, the first indicia forming surface configured to form the indicia on at least the first surface; and (2) a second tool in opposing relationship with the first tool, the second tool proximate to a second surface opposing the first surface of the metal sheet. After forming an indicia on the metal sheet, in one embodiment the apparatus is configured to feed the metal sheet with the indicia to a cupping apparatus. The first indicia forming surface can be dome shaped. In one embodiment, the first indicia forming surface is convex.

Optionally, the second tool further comprises a second indicia forming surface to apply a force to the second surface of the metal sheet. The second indicia forming surface can be configured to form an indicia on one or more of the first surface and the second surface of the metallic sheet. In one embodiment, the second indicia forming surface is generally dome shaped. The second indicia forming surface can be concave.

In one embodiment, the first tool further includes a plurality of apertures that extend through the first indicia forming surface. An extension can be affixed to the first indicia forming surface. A fluid may be selectively forced through one or more of the plurality of apertures to apply a hydraulic force to the extension. The extension is configured to move away from the first indicia forming surface in response to the hydraulic force. In this manner, the extension can selectively apply a force to the first surface in response to a fluid transmitted through the apertures. The fluid can be an oil, water, or a gas.

Optionally, one or more of the apertures can vent a fluid, such as air, away from the metal sheet as the first and second tools are brought into contact with the metal sheet. Venting the fluid prevents, or eliminates, air pockets from forming. Additionally, or alternatively, the second tool may include an extension that is the same as, or similar to, the extension of the first tool. Apertures may be included in the second tool to transmit a fluid to apply a force to the extension of the second tool.

In one embodiment, a valve controls the transmission of fluid through the apertures of one or more of the first and second tools. Optionally, each of the first and second tools includes a valve to control the transmission of fluid through apertures of the first and second tools.

Another aspect of the present invention is a bodymaker including tools to form an indicia including one or more of an embossed portion and a debossed portion on a closed dome portion of a metallic container body. The bodymaker generally comprises: (1) a dome die having a convex surface to apply a force to an exterior surface of the container body, the convex surface configured to form the indicia on at least the exterior surface of the metallic container body; and (2) a punch bolt in opposing relationship to the convex surface of the dome die, the punch bolt including a concave surface configured to contact an interior surface of the metallic container body. Optionally, the indicia is formed on each of the exterior surface and the interior surface of the metallic container body.

In one embodiment, the convex surface of the dome die includes a geometric profile configured to form the indicia. Optionally, the geometric profile is recessed into the convex surface. Additionally, or alternatively, the geometric profile projects from the convex surface. In another embodiment, the geometric profile is configured to form one or more of a symbol, a numeral, and a letter in the closed dome portion of the metallic container body.

Optionally, the concave surface of the punch bolt includes a second geometric profile. In one embodiment, the second geometric profile is a negative of the geometric profile of the dome die. In another embodiment, the second geometric profile is a positive of the geometric profile of the dome die. The second geometric profile of the punch bolt can be configured to form an indicia on one or more of the exterior surface and the interior surface of the metallic container body.

One or more of the dome die and the punch bolt can have a geometric profile configured to form an indicia that imparts structural strength to the closed dome portion. The geometric profile can include one or more of a ridge and a groove. The ridge and the groove can optionally have a generally oval shape. The ridge and the groove can have a predetermined length extending between a first end and a second end. The first end of the ridge and the groove can be positioned proximate to a peripheral edge of the convex surface of the dome die or the concave surface of the punch bolt. The second end of the ridge and the groove can be positioned proximate to a longitudinal axis of the dome die or a longitudinal axis of the punch bolt, the longitudinal axis extending substantially perpendicular to the respective convex surface of the dome die and the concave surface of the punch bolt. In one embodiment, the second end of the ridge and the groove is spaced from a center portion of the convex surface and the concave surface. The depth of the groove and the height of the ridge can vary along the length of the groove and the ridge. The first end of the groove can have a first depth that is different than a second depth of the second end. In one embodiment, the depth of the groove increases from the first end to the second end. Accordingly, the first depth can be less than the second depth. Similarly, the first end of the ridge can have a first height and the second end of the ridge can have a second height. Optionally, the first height is less than the second height. In one embodiment, the dome die or the punch bolt can have three or more ridges or three or more grooves. In another embodiment, the dome die or the punch bolt have six grooves or six ridges. The grooves and the ridges can extend outwardly from the longitudinal axis of the dome die or the longitudinal axis of the punch bolt. In one embodiment, the ridges or the grooves are arranged similar to spokes of a wheel.

In one embodiment, the bodymaker is configured to advance the punch bolt toward the dome die. The punch bolt can optionally be interconnected to a punch of the bodymaker. The punch is configured to advance the punch bolt toward the dome die. In one embodiment, the punch bolt, punch, and the dome die are substantially concentrically aligned. The dome die can be interconnected to the bodymaker such that the dome die is substantially stationary when the indicia is formed.

In one embodiment, at least one of the dome die and the punch bolt further includes a plurality of apertures that extend through the respective convex and concave surfaces to an extension interconnected thereto. The apertures are configured to selectively transmit a fluid to apply pressure to the extension. The extension is configured to extend away from the convex surface or the concave surface in response to a hydraulic pressure received from the fluid. In this manner, the extension selectively applies a force to one or more of the exterior surface and the interior surface of the metallic container body to form the indicia. In one embodiment, at least one of the apertures is configured to vent a fluid from the closed dome portion of the metallic container body. Optionally, the extension is formed of a urethane of a predetermined hardness. The fluid can be a gas such as air or a liquid. In one embodiment, the liquid is an oil or water.

Optionally, the bodymaker includes at least one valve associated with the apertures. The valve is operable to control the flow of fluid transmitted through the apertures. One or more of a volume, a pressure, a timing of fluid transmitted through the apertures can be controlled by the valve. The dome die and the punch bolt may include one or more valves associated with the apertures.

In one embodiment, the dome die includes a first group of apertures and a second group of apertures. A first valve can be associated with the first group. A second valve can be associated with the second group. The first valve can operate independently of the second valve. For example, the first valve may open to transmit fluid to the first group of apertures while the second valve is closed. Additionally, or alternatively, the first valve may transmit fluid at a different pressure than the second valve. In this manner, the first valve can control the formation of a first indicia and the second valve can control the formation of a second indicia. In one embodiment, the first and second indicia may be formed on the metallic container body. Additionally, or alternatively, the bodymaker may open the first valve and close the second valve to form a first indicia on a first metallic container body. In another embodiment, the bodymaker can close the first valve and open the second valve to form a second indicia on a second metallic container body.

One aspect of the present invention is a method of forming one or more of an emboss and a deboss on a closed dome portion of a container body. The method generally includes, but is not limited to, one or more of: (1) forming at least one of an emboss and a deboss on at least a first surface of a metal sheet; (2) forming a cup from the metallic sheet by a cupping apparatus; and (3) forming the cup into a container body by a bodymaker, the container body including a closed dome portion with the emboss/deboss in a predetermined location. In one embodiment, the emboss extends outwardly from an exterior surface of the closed dome portion. In another embodiment, the deboss extends inwardly from the exterior surface of the closed dome portion.

Optionally, in one embodiment, the method further includes applying a clamping force to a closed end-wall of the cup by the bodymaker. The clamping force may be applied to the closed-end-wall before the bodymaker forms the cup into the container body. In one embodiment, the clamping force is selected to prevent stretching or pulling of a clamped portion of the closed end-wall by the bodymaker. In this manner, the emboss and/or the deboss formed on the metal sheet is not altered when the bodymaker forms the cup into the container body.

Another aspect of the present invention is a method of forming a decorative shape or an indicia on a closed dome portion of a metallic container body by a bodymaker. The method generally comprises: (1) positioning a metallic cup in the bodymaker; (2) positing a punch bolt within an interior of the metallic cup; and (3) compressing a closed end-wall of the metallic cup between the punch bolt and a dome die to form the container body with a closed dome portion, the dome die having a convex surface configured to form the indicia on a predetermined portion of the closed dome portion. In one embodiment, the indicia extends outwardly from an exterior surface of the closed dome portion. Additionally, or alternatively, in another embodiment the indicia extends inwardly from the exterior surface of the closed dome portion.

It is another aspect of the present invention to provide a method of forming a metallic container body including a closed dome portion with an indicia. The method includes, but is not limited to, one or more of: (1) providing a metallic cup with a closed end-wall; (2) positioning the metallic cup in a bodymaker operable to form the metallic cup into the metallic container body, the bodymaker including a dome forming die opposing a punch bolt; and (3) applying a force with the dome forming die to an exterior surface of the closed end-wall, one or more of the dome forming die and the punch bolt being configured to form the indicia in a predetermined location of the closed dome portion. The dome forming die and the punch bolt are configured to form the closed dome portion of the metallic container body. In one embodiment, the dome forming die and the punch bolt form the closed dome portion by reforming the closed end-wall of the metallic cup. The closed dome portion of the metallic container body includes a convex portion within an interior of the metallic container body.

In one embodiment, applying the force forms the indicia by causing a metallic material of the metallic cup to extend outwardly from an exterior surface of the closed dome portion. Additionally, or alternatively, applying the force forms the indicia by causing a metallic material of the metallic cup to extend inwardly from an exterior surface of the closed dome portion.

The dome forming die can include a convex surface. The convex surface can be configured to form the indicia. In one embodiment, the dome forming die has a geometric profile configured to form the indicia. The geometric profile can be formed on the convex surface. In one embodiment, the geometric profile of the dome forming die includes one or more of a groove and a ridge.

The punch bolt optionally includes a concave surface. In one embodiment, the punch bolt is configured to form the indicia. For example, the concave surface of the punch bolt can have a geometric profile configured to form the indicia. Optionally, the geometric profile of the punch bolt includes one or more of a groove and a ridge.

In one embodiment, the method further includes advancing the punch bolt toward the dome die. The punch bolt can optionally be interconnected to a punch of the bodymaker. The punch is configured to advance the punch bolt toward the dome die. In one embodiment, the punch bolt, punch, and the dome die are substantially concentrically aligned. The dome die can be interconnected to the bodymaker such that the dome die is substantially stationary when the indicia is formed.

Optionally, applying the force comprises forcing a fluid through an aperture of the dome forming die. The method may also include forcing a fluid through an aperture of the punch bolt. In one embodiment, the fluid exerts a hydraulic pressure to one or more of the exterior surface and an interior surface of the closed end-wall to form the indicia. In another embodiment, the fluid transmits the hydraulic pressure on an extension interconnected to one or more of the dome forming die and the punch bolt to apply the force to the closed end-wall to form the indicia on the closed dome portion. The fluid can be a liquid (such as an oil or water) or a gas (for example, air).

The method may further include actuating a valve to control the fluid forced through an aperture of the dome forming die or the punch bolt. The valve, in one embodiment, can control one or more of a volume, a pressure, and a timing or duration of the fluid forced through the apertures. Optionally, a first valve is associated with the dome forming die and a second valve is associated with the punch bolt.

Another aspect is a metallic container body with a dome having an indicia. The metallic container body generally includes, but is not limited to: (1) a closed end-wall with a dome extending inwardly; (2) a sidewall extending from the closed end-wall; (3) an open end opposite the closed end-wall; and (4) an indicia formed in a metallic material of the closed end-wall, the indicia extending into or from a surface of the dome. The indicia may optionally comprise one or more of a symbol, a numeral, and a letter.

The indicia can include a groove or flute. The groove can be generally aligned with a radius of the closed end-wall. In one embodiment, the groove extends outwardly from a longitudinal axis of the metallic container body, the longitudinal axis extending substantially perpendicular to the dome. Optionally, the groove can have a shape that is generally oval. The groove can have a predetermined length extending between a first end and a second end. The first end of the groove can be positioned proximate to the sidewall of the metallic container body. The second end of the groove can be positioned proximate to the longitudinal axis that is generally perpendicular to the dome. Optionally, the second end is proximate to a central portion of the dome. In one embodiment, the second end of the groove is spaced from the central portion of the dome. Optionally, the groove can have a predetermined depth. In one embodiment, the depth of the groove varies along the length of the groove. The first end of the groove and can have a first depth that is different than a second depth of the second end. In one embodiment, the depth of the groove increases from the first end to the second end. Accordingly, the first depth can be less than the second depth. Alternatively, the first depth can be greater than the second depth. Optionally, the indicia can comprise a plurality of grooves. In one embodiment, the indicia comprises three grooves. The second ends of the grooves can contact each other. In another embodiment, each groove is separately formed such that the second ends do not contact each other. In one embodiment, the indicia comprises six grooves. Optionally, the grooves can be arranged in a pattern similar to petals of a flower.

In one embodiment, the indicia projects outwardly from an exterior surface of the dome. The exterior surface of the dome is generally concave. In another embodiment, the indicia projects inwardly into an exterior surface of the dome. Optionally, the indicia projects into an interior surface of the dome. Additionally, or alternatively, the indicia projects outwardly from an interior surface of the dome.

In one embodiment, the indicia is formed on a metallic sheet by an embossing/debossing apparatus. The embossing/debossing apparatus generally includes a first tool and a second tool configured to form the indicia on one or more surfaces of the metallic sheet. A portion of the metallic sheet which includes the indicia can subsequently be formed into a cup such that the indicia is positioned on a closed end-wall of the cup. The cup can subsequently be formed into the metallic container body.

Alternatively, in another embodiment the indicia is formed by one or more of a dome forming die and a punch bolt of a bodymaker. The dome forming die and the punch bolt can be configured to form a metallic cup into the metallic container body. In one embodiment, the dome forming die has a geometric profile configured to form the indicia when the bodymaker forms the metallic container body. Additionally, or alternatively, the punch bolt can optionally include a geometric profile configured to form the indicia when the bodymaker forms the metallic container body.

As used herein, the term “emboss” refers to an indicia, mark, geometric profile, or predetermined shape which stands out from a surface of a metallic metal. More specifically, the indicia or shape is raised at least partially above the surface of the metallic material.

The term “deboss” generally refers to an indicia, mark, geometric profile, or a predetermined shape that is indented or recessed into a surface of a metal material.

The terms “metal” or “metallic” as used hereinto refer to any metallic material that may be used to form a container, including without limitation aluminum, steel, tin, and any combination thereof.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about” or “approximately”. Accordingly, unless otherwise indicated, all numbers expressing quantities, dimensions, conditions, ratios, ranges, and so forth used in the specification and claims may be increased or decreased by approximately 5% to achieve satisfactory results. In addition, all ranges described herein may be reduced to any sub-range or portion of the range, or to any value within the range without deviating from the invention.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

The Summary is neither intended, nor should it be construed, as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary as well as in the attached drawings and the Detailed Description and no limitation as to the scope of the present invention is intended by either the inclusion or non-inclusion of elements or components. Additional aspects of the present invention will become more readily apparent from the Detailed Description, particularly when taken together with the drawings.

### BRIEF DESCRIPTION OF THE DRAWINGS

The accompanying drawings, which are incorporated herein and constitute a part of the specification, illustrate embodiments of the invention and together with the Summary given above and the Detailed Description given below serve to explain the principles of these embodiments. In certain instances, details that are not necessary for an understanding of the disclosure or that render other details difficult to perceive may have been omitted. It should be understood, of course, that the present invention is not necessarily limited to the particular embodiments illustrated herein. For example, it is contemplated that various features and devices shown and/or described with respect to one embodiment may be combined with or substituted for features or devices of other embodiments regardless of whether or not such a combination or substitution is specifically shown or described herein. Additionally, it should be understood that the drawings are not necessarily to scale.

FIG. 1 is a schematic flow diagram of a prior art method and apparatus used to form a container body;

FIG. 2 is a schematic flow diagram of a system and a method of the present invention of forming an embossed or debossed indicia on a closed end-wall of a container body with an apparatus which forms the indicia on a sheet of stock material;

FIG. 3 is a cross-sectional elevation view of an apparatus operable to form an embossed/debossed indicia on a sheet of stock material and further illustrating a cupping apparatus which subsequently forms a cup with the indicia from the sheet;

FIG. 4 is a top perspective view of a tool of one embodiment of the present invention;

FIG. 5 is a top plan view of a tool of another embodiment of the present invention;

FIG. 6 is a schematic flow diagram of another system and method of forming an embossed/debossed indicia on a closed end-wall of a container body according to another embodiment of the present invention, the system and method including a bodymaker with a tool which forms the indicia on the closed end-wall; and

FIGS. 7-8 are partial longitudinal cross-sectional views of embodiments of tools of a bodymaker of the present invention, the tools operable to form decorative shapes or embossed/debossed indicia on a closed end-wall of a container body.

To assist in the understanding of one embodiment of the present invention the following list of components and associated numbering found in the drawings is provided herein:

| Number | Component |
|---|---|
| 2 | Coil of sheet metal material |
| 4 | Uncoiler |
| 6 | Cupping apparatus |
| 8 | Metallic cup |
| 10 | Bodymaker |
| 12 | Container body |
| 14 | Closed end-wall |
| 15 | Exterior surface of end-wall |
| 16 | Dome |
| 17 | Interior surface of end-wall |
| 18 | Sidewall |
| 20 | Open end |
| 22 | Downstream equipment |
| 24 | Method |
| 26 | Embossing/Debossing apparatus |
| 28 | First tool |
| 30 | First indicia forming surface |
| 31 | Geometric profile |
| 32 | Apertures |
| 33 | Group of apertures |
| 34 | Extension |
| 36 | Second tool |
| 38 | Second indicia forming surface |
| 40 | Metal sheet |
| 42 | First surface of metal sheet |
| 44 | Second surface of metal sheet |
| 48 | Container body |
| 50 | Closed end-wall |
| 52 | Dome |
| 54 | Exterior surface of end-wall |
| 56 | Sidewall |
| 58 | Embossed/debossed indicia |
| 60 | Method |
| 62 | Bodymaker |
| 64 | Dome forming die |
| 66 | Convex surface |
| 68 | Apertures |
| 70 | Extension |
| 71 | Punch |
| 72 | Punch bolt |
| 74 | Concave surface |

### DETAILED DESCRIPTION

The present invention has significant benefits across a broad spectrum of endeavors. It is the Applicant's intent that this specification and the claims appended hereto be accorded a breadth in keeping with the scope and spirit of the invention being disclosed despite what might appear to be limiting language imposed by the requirements of referring to the specific examples disclosed. To acquaint persons skilled in the pertinent arts most closely related to the present invention, a preferred embodiment that illustrates the best mode now contemplated for putting the invention into practice is described herein by, and with reference to, the annexed drawings that form a part of the specification. The exemplary embodiment is described in detail without attempting to describe all of the various forms and modifications in which the invention might be embodied. As such, the embodiments described herein are illustrative, and as will become apparent to those skilled in the arts, may be modified in numerous ways within the scope and spirit of the invention.

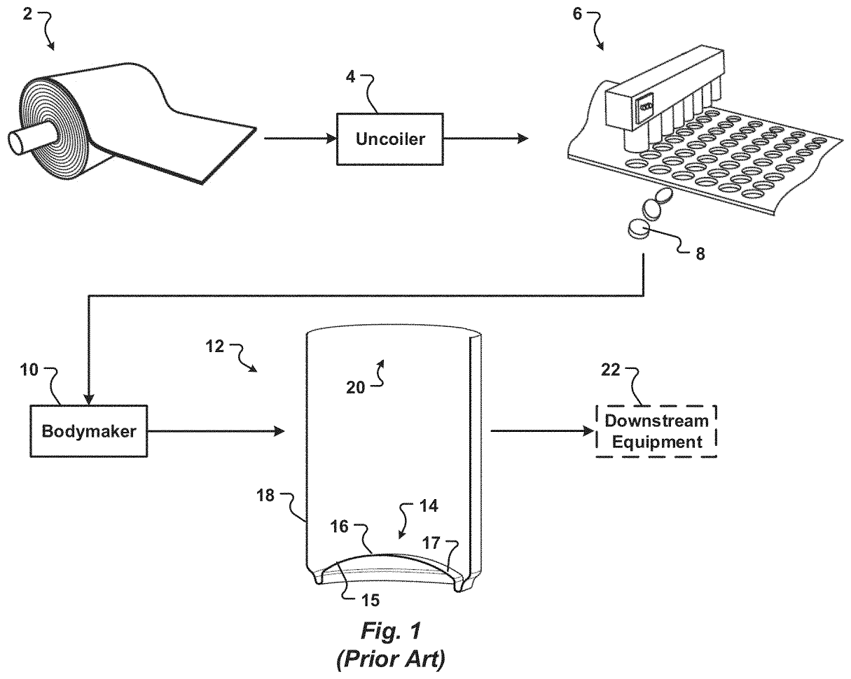

Referring now to FIG. 1, a prior art method of forming a container body 12 is generally illustrated. A cupping apparatus 6 punches cups 8 from a sheet of stock metal. The cups 8 are subsequently transported to a bodymaker 10 operable to form the cups into container bodies 12. Downstream equipment 22, such as a decorator, may form a decoration or indicia on the container bodies using an ink, a paint, a varnish, or another coating or by forming a decoration with a laser.

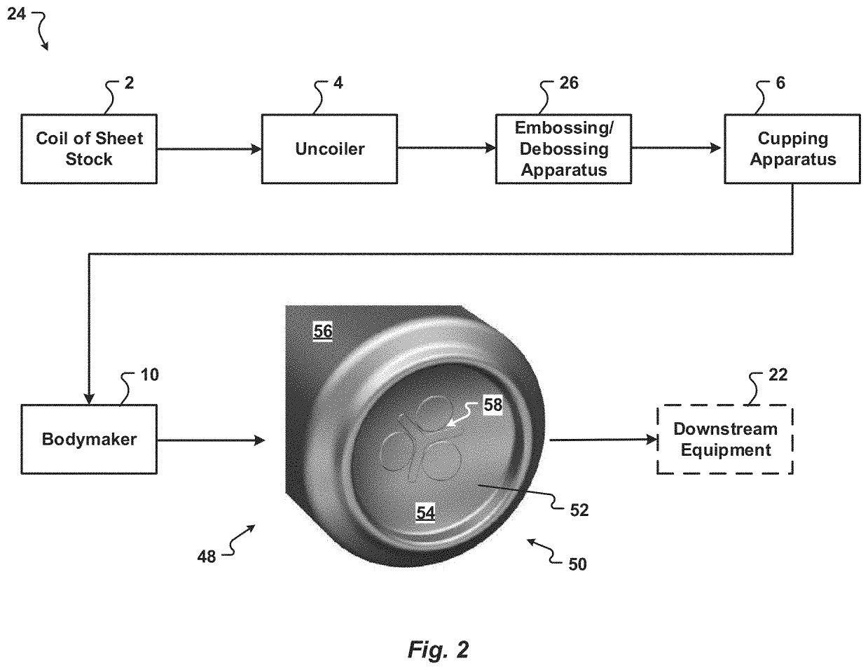

Referring now to FIG. 2, a method 24 of forming an embossed/debossed indicia 58 on a closed end-wall 50 of a container body 48 according to one embodiment of the present invention is generally illustrated. Method 24 is similar to the prior art method illustrated in FIG. 1 and includes similar apparatus and operations. However, method 24 includes a novel embossing/debossing apparatus 26 of one embodiment of the present invention. In one embodiment, method 24 optionally begins when a coil 2 of sheet metal 40 is loaded onto an uncoiler 4. The embossing/debossing apparatus 26 receives the sheet metal 40 from the uncoiler 4. In one embodiment, the embossing/debossing apparatus 26 is separate from the cupping apparatus 6.

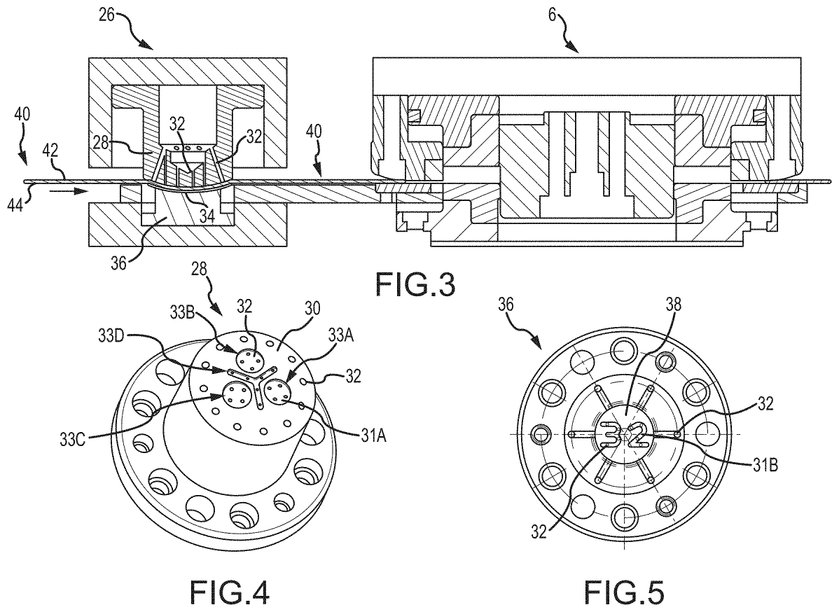

Referring now to FIGS. 3-5, the embossing/debossing apparatus 26 includes tools 28, 36 to form an indicia 58 on the metal sheet 40. More specifically, the embossing/debossing apparatus 26 includes tools 28, 36 to form an indicia 58 on at least one surface 42, 44 of the metal sheet 40. In FIG. 3, a cupping apparatus 6 is illustrated downstream from the embossing/debossing apparatus 26 to receive the metal sheet 40 including the indicia 58. Although the embossing/debossing apparatus 26 is illustrated as being separate from the cupping apparatus 6, in one embodiment the embossing/debossing apparatus 26 is incorporated into the cupping apparatus. More specifically, the tools 28, 36 can be configured to form the indicia 58 an create a cup 8 with a closed end-wall including the indicia.

The embossing/debossing apparatus 26 may include a first tool 28 to apply a force to a first surface 42 of the metal sheet 40. The first tool 28 can have a shape to form an indicia on the first surface 42. A second surface 44 of the metal sheet 40 may be supported by a second tool 36 of the embossing/debossing apparatus 26 as the first tool 28 contacts and applies the force to the first surface 42. In one embodiment, the first surface 42 of the metallic sheet 40 subsequently becomes an interior surface of a closed end-wall 50 of a container body 48, for example, when a bodymaker 10 subsequently draws and redraws a metallic cup 8 including the indicia one or more times. Alternatively, in another embodiment, the first surface 42 can become an exterior surface 54 of the closed end-wall 50.

Optionally, the second tool 36 may be configured to form a second indicia on the second surface 44 of the metal sheet. In one embodiment, the second indicia is different from the first indicia 58. More specifically, the embossing/debossing apparatus 26 may form two different indicia on the respective first and second surfaces 42, 44 of the metal sheet 40 similar to a coin, such as a penny, which has different images on each side.

Referring now to FIG. 4, a first tool 28 with a first indicia forming surface 30 of one embodiment of the present invention is generally illustrated. In one embodiment, the first indicia forming surface 30 incudes a geometric profile 31A. The geometric profile 31A can be configured to form the embossed/debossed indicia 58 on the container body 48. In one embodiment, the geometric profile 31A is recessed inwardly into the first indicia forming surface 30. Additionally, or alternatively, the geometric profile 31A can extend outwardly from the first indicia forming surface 30.

The first tool 28 may be interconnected to the embossing/debossing apparatus 26 to form an indicia 58 on at least a first surface 42 of a metal sheet 40. The first indicia forming surface 30 may be configured to form an indicia 58 having one or more of raised and recessed portions on the metal sheet 40. In one embodiment, the first indicia forming surface 30 has a generally convex shape. One of skill in the art will appreciate that the first indicia forming surface 30 may include a geometric profile 31A configured to form any desired indicia 58 on a container body 48 and is not limited to the embodiment illustrated in FIG. 4.

Optionally, the first indicia forming surface 30 may be configured to form at least the first surface 42 of the metal sheet 40 such as to increase the strength of a closed end-wall 50 of a container body 48 subsequently formed therefrom. More specifically, the indicia 58 formed by the first tool 28 can have a shape to resist deformation due to internal fluid pressures of a product stored in the container body 48. In one embodiment, the geometric profile of the first tool is configured to form an indicia 58 including one or more of a radial groove and a flute configured to prevent inadvertent or unintended deformation of the closed end-wall 50. As one of skill in the art will appreciate, the pressure at which the dome 52 of a container body 48 is deformed or reversed is often called the “static dome reversal pressure.” Accordingly, in one embodiment, the indicia 58 formed by the first tool 28 has a shape selected to increase the static dome reversal pressure of the container body dome 52. Additionally, or alternatively, in another embodiment, the indicia 58 can be shaped to increase resistance to reversal or deformation of the closed end-wall 50 and/or the dome 52 due to impacts or forces during handling of a container body 48, such as arising when the container body is dropped. Accordingly, the geometric profile 31A formed on the first indicia forming surface 30 can have a shape to help achieve a beverage container body 48 that will maintain its integrity and/or form due to internal pressure or external forces.

Optionally, in one embodiment of the present invention, the first tool 28 includes a plurality of apertures 32. The apertures 32 can extend through the first indicia forming surface 30. In one embodiment, the apertures 32 only extend through portions of the geometric profile 31A. A valve (not illustrated) can be associated with one or more of the apertures 32. The valve can be configured and operable to control the flow of fluid through one or more of the apertures. More specifically, the valve can control at least one of a volume, a pressure, and a timing of the fluid being discharged from the apertures 32. In this manner, a fluid can be selectively transmitted through one or more of the apertures 32 to the first indicia forming surface 30. The fluid can be a gas (such as air) or a liquid (for example, water or an oil).

An extension 34 (illustrated in FIG. 3) can be affixed to the first indicia forming surface 30. The fluid can be transmitted through one or more of the apertures 32 to impart a hydraulic pressure to selected portions of the extension 34. Optionally, the fluid can be transmitted through the apertures when the first tool 28 is in contact with the first surface 42 of the metal sheet. In response to the pressure, the extension 34 deforms away from the first tool 28 and applies a force to the first surface 42 of the metal sheet 40 to form the indicia 58. The extension 34, optionally, is formed of a material which is at least partially compressible. In one embodiment, the material of the extension 34 has a predetermined hardness. In another embodiment, the extension 34 is formed of a urethane. The fluid can also be used to lubricate or cool the tools 28, 36 of the embossing/debossing apparatus 26.

Optionally, the apertures 32 may be associated into one or more groups 33. A group 33 of apertures 32 may be associated with a portion of the geometric profile 31A. For example, in one embodiment, a first portion of the geometric profile 31A includes a group 33A of apertures 32. In one embodiment, each group 33 of apertures may be associated with a valve. The valves associated with each group can independently control one or more of a volume, a timing, and a pressure of fluid transmitted through the apertures 32 of the groups 33. Different valves or combinations of valves may be actuated to transmit fluid during the formation of an indicia 58. Accordingly, in one embodiment, a first valve can control the transmission of fluid through apertures of a first group 33A while a second valve will control the transmission of fluid through apertures of a second group 33B. The first valve may open to transmit fluid through apertures 32 of the first group 33A during formation of an indicia 58 at a time when the second valve is closed to prevent fluid flowing through the second group 33B. In this manner, an indicia 58 formed by the geometric profile 31 of tool 28 may be altered by allowing, or preventing, the fluid to pass through apertures 31 of one or more groups 33.

Referring now to FIG. 5, a second tool 36 of one embodiment of the present invention is generally illustrated. The second tool 36 can be interconnected to the embossing/debossing apparatus 26 proximate to the second surface 44 of the metal sheet 40. In one embodiment, the second tool 36 supports the second surface 44 as the first tool 28 applies force to the first surface 42.

Optionally, the second tool 36 includes a second indicia forming surface 38. In one embodiment, the second indicia forming surface 38 has a geometric profile 31B with a geometric profile selected to form a decorative shape or an indicia 58 on at least the second surface 44 of the metal sheet 40. In one embodiment, the second indicia forming surface 38 is a negative of the first indicia forming surface 30 of the first tool 28. More specifically, in one embodiment, the second indicia forming surface 38 has a negative shape and the first indicia forming surface 30 has a positive shape. Alternatively, in another embodiment, the geometric profile 31B of the second indicia forming surface 38 has a geometric profile to form a unique decorative shape or indicia on the second surface 44 which is different than an indicia formed by the geometric profile 31A of the first tool 28. Optionally, the second indicia forming surface 38 has a shape that is generally concave.

The geometric profile 31B of the second indicia forming surface 38 can be shaped to form an indicia 58 having one or more of symbols, shapes, numerals, and letters which can be raised from, or recessed into, the surfaces 42, 44 of the metal sheet. For example, the geometric profile 31B of the second tool 36 illustrated in FIG. 5 is configured to form the number “32”.

In one embodiment, the geometric profile of one or more of the first tool 28 and the second tool 36 can include at least one of a ridge and a groove configured to form an indicia 58 with a shape selected to resist deformation. The ridge and the groove can have a shape that is generally oval. The ridge and the groove can have a predetermined length extending between a first end and a second end. The first end of the ridge and the groove can be positioned proximate to a peripheral edge of the first tool 28 and the second tool 36. The second end of the ridge and the groove can be positioned proximate to a longitudinal axis of the first tool 28 and the second tool 36, the longitudinal axis substantially perpendicular to a convex surface of the first tool 28 or the concave surface of the second tool 36. In one embodiment, the second end of the ridge and the groove is spaced from a center portion of the convex surface and the concave surface. The groove can have a predetermined depth. The ridge can have a predetermined height. The depth of the groove and the height of the ridge can vary along the length of the groove and the ridge. The first end of the groove can have a first depth that is different than a second depth of the second end. In one embodiment, the depth of the groove increases from the first end to the second end. Accordingly, the first depth can be less than the second depth. Alternatively, the first depth can be greater than the second depth. Similarly, the first end of the ridge can have a first height and the second end of the ridge can have a second height. The second height can be greater than the first height. Optionally, the second height can be less than the first height. In one embodiment, the geometric profile 31A, 31B can have three or more ridges or three or more grooves. In another embodiment, the first tool 28 and the second tool 36 can have six grooves 31 or six ridges 31. The grooves and the ridges of the geometric profile 31 can extend outwardly from the longitudinal axis of the first tool 28 or the longitudinal axis of the second tool 36. Optionally, the grooves and the ridges are arranged in a pattern similar to petals of a flower.

In one embodiment, an extension 34 can be interconnected to the second indicia forming surface 38. The extension 34 may be the same as, or similar to, the extension 34 affixed to the first tool 28. Accordingly, the second tool 36 can include apertures 32 that extend through the second indicia forming surface 38. A fluid can be transmitted through one or more of the apertures 32 to the second indicia forming surface 38. In one embodiment, the fluid can be selectively transmitted through one or more of the apertures 32 to impart a hydraulic pressure to predetermined portions of the extension 34. Optionally, the fluid can be transmitted through the apertures 32 before, or after, the second tool 36 is in contact with the second surface 44. In response to the pressure, the extension 34 deforms away from the second tool 36 and applies a force to the second surface 44 to form the indicia 58.

The apertures 32 of the second tool 36 may be associated into one or more groups 33 similar to the apertures of the first tool 28. Optionally, one or more valves may be associated with the apertures. In one embodiment, a valve is associate with each group of apertures. The valves may be the same as the valve described in conjunction with FIG. 4.

Referring again to FIG. 2, in one embodiment, a cupping apparatus 6 receives the metal sheet 40 including the decorative shape or indicia 58 from the embossing/debossing apparatus 26. The cupping apparatus 6 cuts a blank which includes the indicia 58 from the metal sheet 40. In one embodiment, the blank is generally circular. An example of a cupping apparatus 6 which can be used with the systems and methods of the present invention is described in U.S. Pat. No. 6,032,505 which is incorporated herein in its entirety by reference.

The blank can be formed into a cup 8 by the cupping apparatus 6. A bodymaker 10 receives the cup and forms the cup into a container body 48. In one embodiment, the bodymaker 10 includes a clamping tool operable to clamp a closed end-wall of the cup 8. A predetermined clamping force is applied to the closed-end-wall by the clamping tool. The clamping force is selected to prevent stretching or pulling of a clamped portion of the closed end-wall by the bodymaker 10. More specifically, the clamping tool prevents pulling or stretching of metal associated with the indicia 58 previously formed in the metal sheet. In this manner, the decorative shape or indicia 58 formed on the metal sheet 40 by the embossing/debossing apparatus 26 is not altered when the bodymaker 10 forms the cup 8 into the container body 48. In one embodiment, the clamping tool of the bodymaker is configured to apply the clamping force to one or more points of the closed end-wall around a perimeter of the decorative shape or indicia 58. In addition, the clamping tool may contact one or more of an exterior surface and an interior surface of the closed end-wall. Various examples of bodymakers 10 which may be used with method 24 of the present invention are described in PCT Publication WO 2014/047115, PCT Publication WO 2014/110387, U.S. Pat. App. Pub 2010/242567, U.S. Pat. App. Pub. 2013/0239644, U.S. Pat. Nos. 5,394,727, 9,079,237, and 9,387,530 which are each incorporated herein in their entirety by reference.

The indicia 58 can be positioned in any predetermined portion of the closed end-wall 50. Optionally, the indicia 58 can extend outwardly from an exterior surface 54 of the closed end-wall. In one embodiment, at least a portion of the indicia 58 is recessed and extends inwardly from the exterior surface 54. The container body 48 can subsequently be transported to downstream equipment 22 where other operations may be performed on the container body. For example, in one embodiment, the downstream equipment 22 includes a decorator operable to decorate the sidewall 56 of the container body 48 with one or more of an ink, a paint, and a varnish.

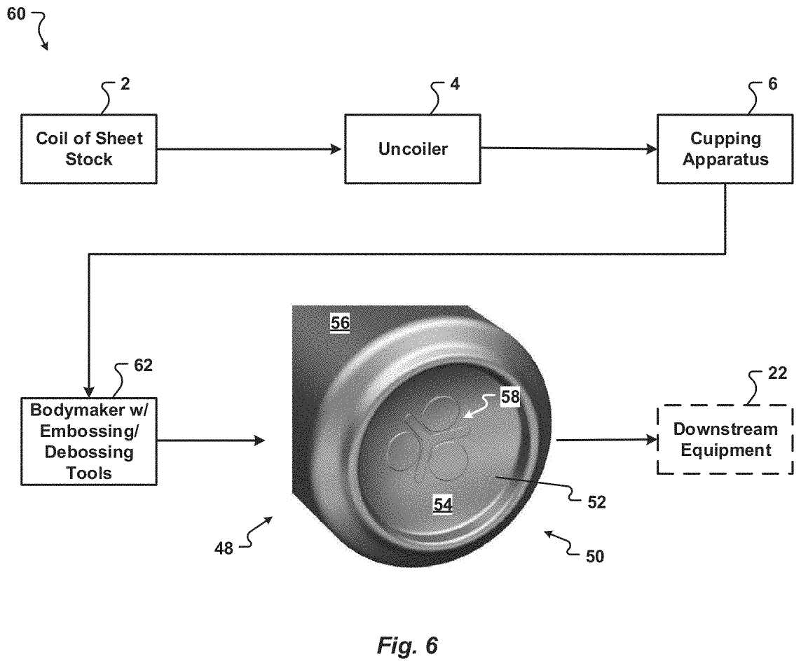

Referring now to FIG. 6, another method 60 of forming a decorative shape or indicia 58 on a closed end-wall 50 of a container body 48 according to another embodiment of the present invention is generally illustrated. One or more operations of method 60 may optionally be omitted. Method 60 is similar to method 24 and the prior art method described in conjunction with FIG. 1 and includes many of the same or similar operations and may use similar tools. Notably, method 60 includes a novel bodymaker 62 with tools 64, 72 configured to form a predetermined shape or an indicia 58 on a closed end-wall while forming a metallic cup 8 into a container body 48.

In one embodiment, method 60 begins when a coil 2 of stock metal is loaded onto an uncoiler 4. A cupping apparatus 6 receives the stock metal material and cuts a blank from the stock metal. In one embodiment, the blank is generally circular. The blank is formed into a cup 8 by the cupping apparatus 6.

A bodymaker 62 of one embodiment of the present invention receives and forms the cup into a container body 48. In one embodiment, the method 60 begins when a cup 8 is loaded into the bodymaker 62.

The bodymaker 62 includes tools 64, 72 operable to form a predetermined shape or an indicia 58 on at least an exterior surface 54 of a closed end-wall 50 of the container body 48. The indicia 58 can be positioned in any predetermined portion of the closed end-wall 50. Optionally, the indicia 58 can extend outwardly from the exterior surface 54 of the closed end-wall. Additionally, or alternatively, in one embodiment at least a portion of the indicia 58 is recessed and extends inwardly from the exterior surface 54. The indicia 58 may be one or more of a symbol, a shape, a numeral, and a letter. In one embodiment, a second indicia may extend from, or be recessed into, an interior surface of the closed end-wall. Similar to the indicia formed by the method 24, the indicia 58 may be configured to increase the strength of the closed end-wall by preventing or resisting buckling and deformation. For example, at least one of the tools 64, 72 can be configured to form an indicia 58 including a radial groove, a flute, a rib or another shape configured to prevent inadvertent or unintended deformation of the closed end-wall 50.

Optionally, the container body 48 is subsequently transported to downstream equipment 22. The downstream equipment may perform one or more other operation on the container body, including applying decorations in the form of inks, paints, or varnishes to a sidewall 56 of the container body 48.

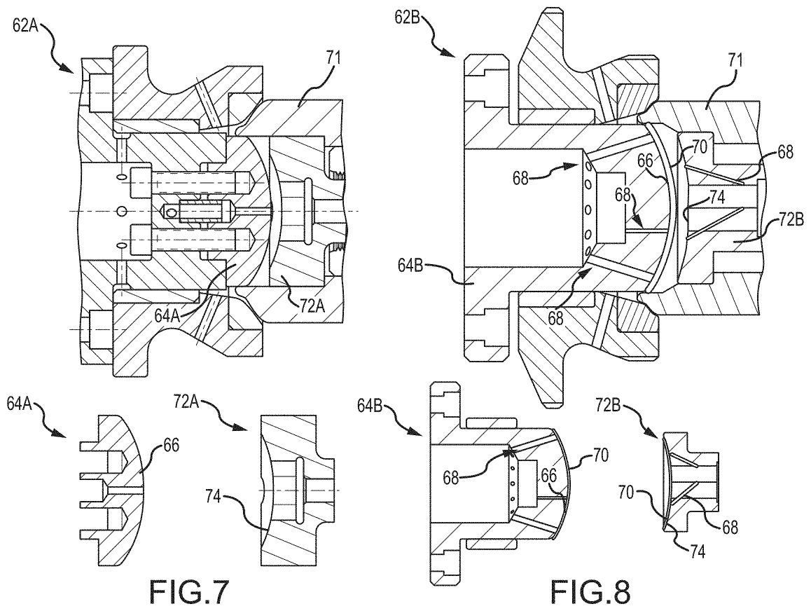

Referring now to FIGS. 7-8, partial views of embodiments of bodymakers 62 and tools 64, 72 of the present invention are generally illustrated. The bodymakers 62 generally include a dome die 64 configured to apply a force to an exterior surface 54 of a closed end-wall 50 of a container body 48. The dome die 64 includes a convex surface 66. A punch 71 and a punch bolt 72 of the bodymaker 62 are configured to be positioned within an interior of a container body 48 as the bodymaker 62 forms the container body 48 from the metallic cup 8. The punch bolt 72 has a concave surface 74.

Optionally, the convex surface 66 of the dome die 64 has a geometric profile selected to form a shape or an indicia 58 on at least the exterior surface 54 of the container body 48. The convex surface 66 may be the same as, or similar to, the first indicia forming surface 30 of the first tool 28 described in conjunction with FIG. 4. Accordingly, in one embodiment, the dome die 64 can include a geometric profile 31 that same as, or similar to, the geometric profile 31 of the first tool 28.

Additionally, or alternatively, the concave surface 74 of the punch bolt 72 can be configured to form a shape or an indicia 58 on the exterior surface 54 of the container body 48. The concave surface 74 can include a geometric profile 31 similar to the indicia forming surface 38 of the second tool 36 describe in conjunction with FIGS. 3-5.

The tools 64, 72 of the bodymakers 62A, 62B can use a coining method to form an indicia 58 on the closed end-wall 50. Accordingly, in one embodiment, one of the dome die convex surface 66 and the punch bolt concave surface 74 includes a geometric profile to form the indicia 58. Optionally, in one embodiment, the concave surface 74 of the punch bolt 72 has a geometric profile that is substantially the negative of a geometric profile of the convex surface 66 of the dome die 64.

Alternatively, and referring now to FIG. 8, in another embodiment of the present invention, an extension 70 is positioned on the convex surface 66 of the dome die 64. The extension 70 may be the same as, or similar to, the extension 34 described herein. The extension 70 can be formed of a material which is at least partially compressible. A hydraulic pressure is applied to one or more selected portions of the extension 70. A fluid can be selectively pumped through apertures 68 of the dome die 64 to provide the hydraulic pressure. In response to the pressure, selected portions of the extension 70 move toward, and apply a force to, selected portions of the exterior surface 54. In this manner, the extension 70 forms an indicia or predetermined shape 58 in the exterior surface. Optionally, the hydraulic pressure is applied to the extension before or during contact between the extension 70 and an exterior surface 54 of the closed end-wall 50.

In one embodiment, an extension 70 can be interconnected to the concave surface 74 of the punch bolt. Accordingly, the punch bolt 72 may include one or more apertures 68 to selectively apply a hydraulic force to the extension. In one embodiment, each of the dome die 64 and the punch bolt 72 include an extension 70.

Optionally, one or more of the dome die 64 and the punch bolt 72 includes a plurality of apertures 68 extending through surfaces 66, 74 to the extension 70. One or more of the apertures 68 can include an associated valve to control the flow of fluid therethrough. The valve associated with an aperture 68 may be independently opened and closed. Accordingly, fluid can be forced through at least one of the apertures 68 to apply the hydraulic pressure to the extension 70.

In one embodiment, the apertures 68 formed through one or more of the dome die 64 and the punch bolt 72 may be the same as, or similar to, the apertures 32 of the first and second tools 28, 36. The apertures 68 may also be associated into one or more groups 33 similar to the apertures of the first tool 28. Optionally, one or more valves may be associated with the apertures 68. The valves are operable to control one or more of a volume, a pressure, and a timing of the flow of fluid through the groups 33 of apertures. The fluid can include a gas (such as but not limited to air) or a liquid (including water or an oil)

In one embodiment, a valve is associate with each group of apertures. Accordingly, fluid may selectively be pumped or forced through one or more of the apertures 68 of the dome die 64 and/or the punch bolt 72 to apply a hydraulic pressure to predetermined portions of the extension 70. The extension 70 then transmits the force to the closed end-wall 50 to form the indicia 58. In one embodiment, the hydraulic pressure forms the indicia 58. In another embodiment the fluid transmitted through the apertures 68 lubricates one or more of the dome die 64, the punch bolt 72, and the container body 48. The fluid can also be used to cool tooling of the bodymaker 62, including one or more of the dome die and punch bolt. Additionally, or alternatively, the hydraulic pressure and/or the fluid transmitted through the apertures 68 may help separate the dome die 64 and punch bolt 72 from the container body 48 after the indicia 58 is formed.

The description of the present invention has been presented for purposes of illustration and description, but is not intended to be exhaustive or limiting of the invention to the form disclosed. Many modifications and variations will be apparent to those of ordinary skill in the art. The embodiments described and shown in the figures were chosen and described in order to best explain the principles of the invention, the practical application, and to enable those of ordinary skill in the art to understand the invention.

While various embodiments of the present invention have been described in detail, it is apparent that modifications and alterations of those embodiments will occur to those skilled in the art. Moreover, references made herein to “the present invention” or aspects thereof should be understood to mean certain embodiments of the present invention and should not necessarily be construed as limiting all embodiments to a particular description. It is to be expressly understood that such modifications and alterations are within the scope and spirit of the present invention, as set forth in the following claims.

What is claimed is:

1. A system to form an indicia on a metal sheet in a container body manufacturing process, comprising:
an uncoiler to unwind a coil that includes the metal sheet;
an indicia forming apparatus to form a first indicia on a first surface of the metal sheet, the indicia forming apparatus positioned downstream from the uncoiler; and
a cupping apparatus to cut a blank with the first indicia from the metal sheet, wherein the cupping apparatus is positioned downstream from the indicia forming apparatus.

2. The system of claim 1, wherein the indicia forming apparatus comprises a first tool to form the first indicia.

3. The system of claim 2, wherein the first tool includes a first indicia forming surface configured to form the first indicia on at least the first surface of the metal sheet.

4. The system of claim 2, wherein the first tool is configured to apply a force to the first surface to form the first indicia.

5. The system of claim 4, wherein the first tool is configured such that the first indicia is recessed into the first surface of the metal sheet.

6. The system of claim 2, wherein the indicia forming apparatus further comprises a second tool with a second indicia forming surface.

7. The system of claim 6, wherein the second tool is configured to apply a force to a second surface of the metal sheet, the second surface opposing the first surface of the metal sheet.

8. The system of claim 7, wherein the first tool faces the first surface of the metal sheet and the second tool faces the second surface of the metal sheet.

9. The system of claim 1, wherein the cupping apparatus includes tools to form the blank into a cup that includes the first indicia.

10. The system of claim 9, further comprising a bodymaker positioned downstream from the cupping apparatus to form the cup into a container body, wherein the first indicia is positioned on a closed end of the container body.

11. A method of forming an indicia on a closed end of a container body, comprising:
uncoiling a coil of a metal sheet with an uncoiler;
forming an indicia on at least a first surface of the metal sheet by an indicia forming apparatus that is positioned downstream from the uncoiler;
feeding the metal sheet into a cupping apparatus that is positioned downstream from the indicia forming apparatus; and
forming a cup from the metal sheet by the cupping apparatus, wherein the cup includes the indicia.

12. The method of claim 11, further comprising:
feeding the cup into a bodymaker positioned downstream from the cupping apparatus; and
forming the cup into the container body by the bodymaker, the container body including the closed end with the indicia in a predetermined location.

13. The method of claim 12, wherein the indicia extends outwardly from an exterior surface of the closed end.

14. The method of claim 12, wherein the indicia extends inwardly from an exterior surface of the closed end.

15. The method of claim 11, wherein the indicia comprises one or more of a symbol, a numeral, and a letter.

16. The method of claim 11, wherein the indicia forming apparatus comprises a first tool to form the indicia.

17. The method of claim 16, wherein the first tool includes a first indicia forming surface configured to form the indicia on at least the first surface of the metal sheet, and wherein the first tool is configured to apply a force to the first surface to form the indicia.

18. The method of claim 17, wherein the first tool is configured such that the indicia is recessed into the first surface of the metal sheet.

19. A system to form an indicia on a closed end-wall of a container body in a manufacturing process, comprising:
an uncoiler to unwind a coil of a sheet of a metal;
an indicia forming apparatus positioned downstream from the uncoiler, the indicia forming apparatus configured to apply a force to a first surface of the metal sheet to form the indicia;
a cupping apparatus positioned downstream from the indicia forming apparatus and including tools to cut a blank with the indicia from the metal sheet, the blank being generally circular, wherein the cupping apparatus is configured to form the blank into a cup that includes the first indicia; and
a bodymaker positioned downstream from the cupping apparatus to form the cup into the container body, wherein the first indicia is positioned on a closed end of the container body.

20. The system of claim 19, wherein the indicia forming apparatus comprises a first tool to form the indicia, and wherein the first tool includes a first indicia forming surface configured to form the indicia on at least the first surface of the metal sheet.
